(19) United States
(12) Patent Application Publication
(10) Pub. No.: US 2010/0307550 A1
(43) Pub. Date: Dec. 9, 2010

(54) Ice Fishing Utilities

(75) Inventors: Murray Silverberg, Oakdale, MN (US); James M. Conlin, North St. Paul, MN (US)

Correspondence Address: NIKOLAI & MERSEREAU, P.A., 900 SECOND AVENUE SOUTH, SUITE 820, MINNEAPOLIS, MN, 55402, US

(73) Assignee: MFP, LLC, North St. Paul, MN (US)

(21) Appl. No.: 12/478,054

(22) Filed: Jun. 4, 2009

(51) Int. Cl. E04H 15/32; E04H 15/56; A01K 97/04; A01K 97/10; B65D 85/00; B65D 85/50; B65D 25/20; B65D 55/02

(52) U.S. Cl. 135/116; 43/55; 43/21.2; 206/315.11; 220/630; 220/737; 206/1.5; 220/500

(57) ABSTRACT

In some embodiments, a portable floor may include one or more of the following features: (a) a frame having a top surface and a bottom surface, (b) a pre-cut hole in the floor adapted to allow a ice-fishing auger, (c) a plug to cover the at least one hole, (d) a container which is attachable to the floor, the container having a hinged top lid providing access to the interior of the container and a fishing rod holder, (e) an insulated material located adjacent to the frame, (f) a non-slip material coupled to the top surface, (g) a means for coupling the container to the floor, (h) a container to store live bait, (i) lights protruding from containers, and (j) cup holders.

### FIELD OF THE INVENTION

Embodiments of the present invention generally relate to fishing. Particularly, embodiments of the present invention relate to ice fishing. More particularly, embodiments of the present invention relate to utilities to make ice fishing more enjoyable.

### BACKGROUND OF THE INVENTION

Ice fishing is an activity of catching fish with lines and fish hooks or spears through an opening in the ice on a frozen body of water. Ice anglers may sit on the stool in the open on a frozen lake, or in a heated cabin on the ice, some with bunks and amenities.

It is a popular pastime in Canada, Finland, Estonia, Norway, Sweden and Germany. In the United States, people from Alaska, Colorado, Montana, Minnesota, Wisconsin, Michigan, New York, the states of New England and other areas with lakes and long, cold winters enjoy the activity.

Ice fishing gear is highly specialized. First, an ice saw, auger or chisel is required to cut a circular hole or larger rectangular hole in the ice. Power augers are sometimes used. A skimmer is used to remove new ice as it forms and to clear slush left from making the hole. During colder periods most ice anglers choose to carry a heater of some type. The heater is for warmth and it also keeps an anglers fishing hole from freezing. When temperatures reach −20° F. or colder it becomes very hard to keep a fishing hole open.

Three main types of fishing occur. Small, light fishing rod with small, brightly colored lures or jigs with bait such as waxworms, fat heads or crappie minnows. Tip-ups, which carry a line attached to a flag which “tips up” when a strike occurs, allow unattended or less-intensive fishing. The line is dragged in by hand with no reel. In spear fishing a large hole is cut in the ice and fish decoys may be deployed. The fisherman sits in a dark ice shanty called a dark house. The fisherman then peers into the water while holding a large spear attached to a line waiting for fish to appear. This method is often used for lake sturgeon fishing. In the United States, many states allow only rough fish to be taken while spear fishing.

Becoming increasingly popular is the use of a flasher, similar to its summer cousin the fish finder. This is a sonar system providing depth information, as well as indicating the presence of fish or other objects. These flashers, unlike most typical fish finders, display the movement of fish and other objects almost instantaneously. The bait being used can often be seen as a mark on the flasher, enabling the angler to position the bait right in front of the fish. Underwater cameras are also now available which allow the user to view the fish and observe their reaction to the lure presentation.

Longer fishing expeditions can be mounted with simple structures. Larger, heated structures can make multi-day fishing trips possible, but these are eschewed by many seasoned fishers, who fish with no protective structure, attired only in heavy winter wear.

A structure with various local names, but often called an ice shanty, ice shack, fish house, shack, bobhouse, or ice hut, is sometimes used. These are dragged or trailered onto the lake using a vehicle such as a snowmobile, ATV or truck. The two most commonly used types are portable and permanent. The portable houses are often made of a heavy material which is usually water tight. The two most common types of portable houses are when your shelter flips behind the user when not needed, or a pop up shelter so the only means out is through a door. The permanent shelters are made of wood or metal and usually have wheels for easy transport. They can be as basic as a bunk heater and holes or having satellite TV, bathrooms, stoves, full size beds and may appear to be more like a mobile home than a fishing house.

In North America, ice fishing is often a social activity. Some resorts have fish houses rented out by the day, often; shuttle service via Snow Track or other vehicles modified to drive on ice is provided. In Finland, solitary and contemplative isolation is often the object of the pastime. In Finland, fishhouses are a rare occurrence, but wearing a sealed and insulated drysuit designed of space-age fabric is not. In North America, houses appear to create a city at locations where fishing is best.

When fishing in a trap-style portable ice shelter the user typically has ice as the floor. The ice, of course, can be very slippery and can melt when using a heater in the portable ice shelter. Prior trap-style portable shelters typically have a pull-over shelter with no floor. The ice can make entering and exiting the shelter dangerous as a slip hazard.

There currently exist portable ice shelters having floors, however they cannot be used for the trap-style ice shelters.

The present invention is different from the cabin-style ice shelter floors because it isn't attached to the ice shelters. It is lightweight and removable and can be used separately from the trap-style ice shelter. There isn't a removable, foldable floor on the market to be used with the trap-style portable ice shelters. Our two containers provide storage and convenience for transporting fishing equipment and live bait to and from your ice shelter. Past containers were placed behind the seats of the ice shelter which made organization and access hard to achieve.

Further, a fisherman would typically need many storage buckets to transport bait and fishing equipment. There are current containers/tackle boxes used for transporting fishing equipment and bait; however, they do not allow easy access to the equipment without the angler needing to reach behind himself or even get up and move. Present containers further do not allow for an angler's equipment to remain stored until the next time they fish.

It would be desirable to have a floor for ice fishing which would insulate the fisherman from the cold of the ice, prevent the fisherman from slipping on the ice and provide precut holes for directly drilling fishing holes in the ice. It would be desirable to have a floor for ice fishing which was portable. It would be desirable to have a chest for carrying bait and other fishing implements. It would be desirable to have a chest having lighting for shinning on an ice hole. It would be desirable to have a fishing chest having holders for ice fishing rods.

### SUMMARY OF THE INVENTION

In some embodiments, a portable floor may include one or more of the following features: (a) a pre-cut hole for an ice fishing auger, (b) at least one handle attached to the top surface, (c) a plug to fit into and cover the pre-cut hole, and (d) a slot in a portion of the plug.

In some embodiments, a portable floor may include one or more of the following features: (a) a frame having a top surface and a bottom surface, (b) a pre-cut hole in the floor adapted to allow a ice-fishing auger, (c) a plug to cover the at least one hole, (d) a container which is attachable to the floor, the container having a hinged top lid providing access to the interior of the container and a fishing rod holder, (e) an insulated material located adjacent to the frame, (f) a non-slip material coupled to the top surface, and (g) a means for coupling the container to the floor.

In some embodiments, a container may include one or more of the following features: (a) a door providing access to the interior of the container, (b) a handle, (c) a fishing rod holder, (d) a battery-powered light protruding from an exterior of the container, (e) a removable false bottom, (f) an additional sealable compartment disposed in the interior of the container for accommodating live fishing bait, (g) at least one cup holder attached to the exterior of the container, and (h) a locking mechanism on the hinged top lid for securing the container lid.

### DESCRIPTION OF THE DRAWINGS

FIG. 1 shows a trap-style ice fishing house in an embodiment of the present invention;

FIG. 2 shows a portable ice fishing floor in an embodiment of the present invention;

FIG. 3 shows a portable ice fishing floor in an embodiment of the present invention;

FIG. 4 shows a portable ice fishing floor in an embodiment of the present invention;

FIG. 5 shows an upper front profile view of containers in an embodiment of the present invention;

FIG. 6 shows a rearview profile view of containers in an embodiment of the present invention;

FIG. 7 shows atop profile view of a container in an embodiment of the present invention; and

FIG. 8 shows a top profile view of a container in an embodiment of the present invention.

### DESCRIPTION OF THE PREFERRED EMBODIMENT

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments of the present invention disclose a fold-up floor designed for trap-style portable ice shelters. Embodiments of the present invention provide relief from sitting on the ice. Embodiments of the present invention help insulate and provide a non-slip surface for entering and exiting an ice shelter. The fold-up floor could also be used as a flotation device if the user ever fell through the ice. The floor could also be used for fisherman without a shelter who wish to fish directly on the ice. Embodiments of the present invention can fold in half and fit into a case for an ice shelter making it convenient and easy to transport two storage containers used for transporting equipment, rods, live bait and lights.

Embodiments of the present invention disclose a removable, foldable and insulated floor which can fold and fit in a sled base of a trap-style portable ice shelter. Embodiments of the present invention also disclose storage containers used for transportation of fishing equipment and live baits (e.g., minnows).

Embodiments of the present invention disclose a foldable floor and two containers. The floor provides utility, warmth, safety and comfort. One container provides a portable way to transport live bait. Another container can provide a portable way to transport fishing equipment and rods to and from the ice house. The containers can set up on the floor providing the comforts of a permanent ice house without losing the versatility of a portable ice shelter.

Embodiments of the present invention provide a safe non-slip floor ice fisherman can use with or without trap-style ice shelters. The containers can limit the amount of cases or buckets needed to house fishing equipment and rods. The containers can be removable and fishing equipment can remain stored until the next outing. Another container can be a portable bait bucket allowing anglers to use multiple kinds of bait. Bait can be stored in the container until the fisherman's next outing. The floor can be transported within an ice shelter and the containers can eliminate the need for other storage containers. Everything you need for ice fishing would be contained and transported in our prototype.

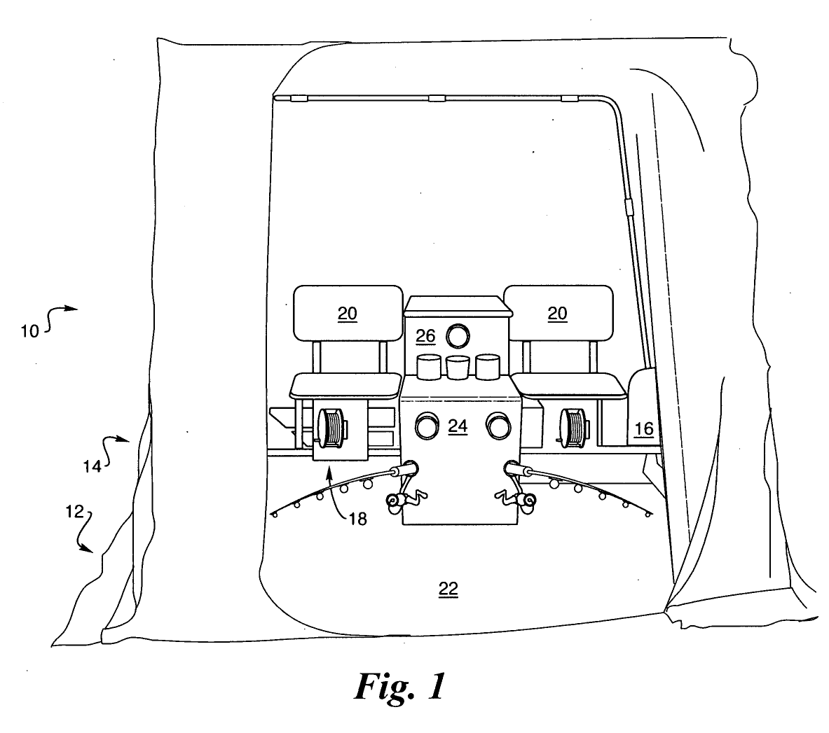

With reference to FIG. 1, a trap-style ice fishing house in an embodiment of the present invention is shown. Trap-style icehouse 10 (icehouse) is a portable icehouse. Icehouse 10 typically folds from front 12 to back 14 in an accordion-like fashion along a metal frame 16. Icehouse 10 is shown fully erected; however, when icehouse 10 is broken down, as just described, it is typically small enough to be stored in tub 18 shown at the back of icehouse 10. Tub 18 typically can support chairs 20 and allow the angler to store other items within tub 18. Also shown in FIG. 1, and in accordance with embodiments of the present invention is a portable ice fishing floor 22 (floor) and portable ice fishing containers 24 and 26.

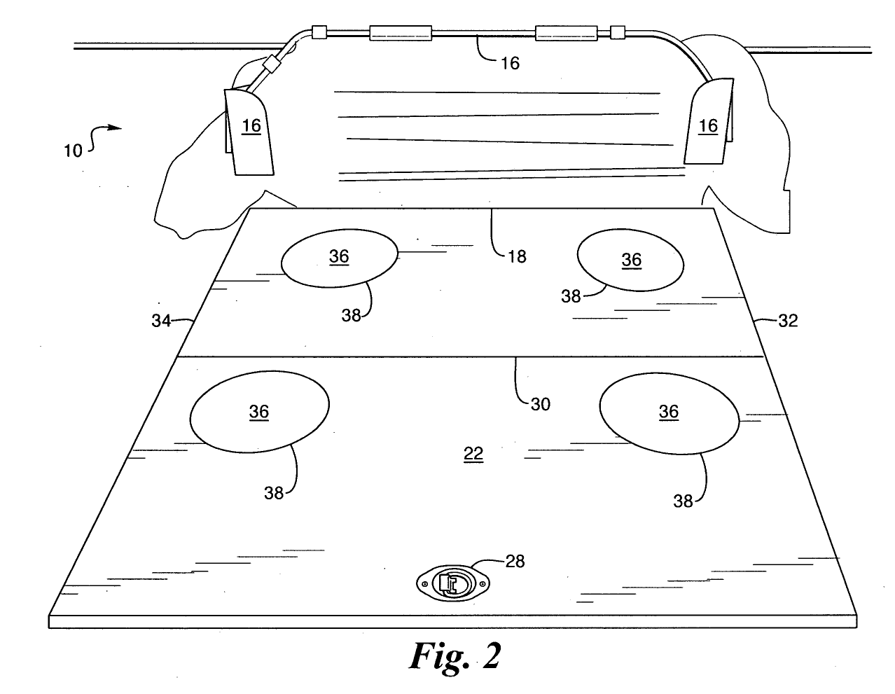

With reference to FIG. 2, a portable ice fishing floor in an embodiment of the present invention is shown. Floor 22 is shown being substantially square; however, it is fully contemplated floor 22 could be most any shape, such as circular, triangular, rectangular or oval, without departing from the spirit of the invention. Floor 22 can have a handle 28 to make it easy for an angler to lift floor 22 off the ice when the angler is finished ice fishing. When picking up floor 22 for transport, floor 22 will typically fold in half along axis 30 which runs from side 32 to opposite side 34. Also shown are plugs 36 which cover ice fishing precut holes 38. FIG. 2 shows 4 precut holes 38; however, it is fully contemplated most any realistic number of precut holes 38 could be within floor 22 without departing from the spirit of the invention. Further, precut holes 38 could be arranged in most any geometric fashion, besides as shown in FIG. 2. Precut holes could be placed anywhere on floor 22.

As shown in the background icehouse 10 is shown broke down and placed within tub 18 for easy transport for the angler.

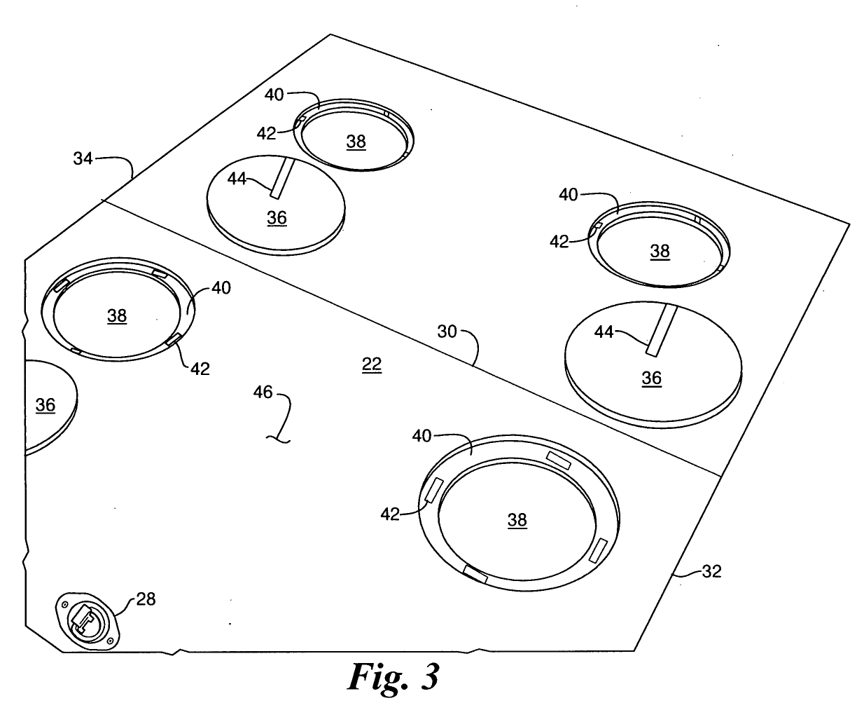

With reference to FIG. 3, a portable ice fishing floor in an embodiment of the present invention is shown. Plugs 36 are shown removed to better show precut holes 38. Precut holes 38 have an indented ridge 40 which runs along the periphery of precut holes 38. Ridges 40 provide a ledge for plugs 36 to rest upon and allow plugs 36 to run smooth with floor 22. Ridges 40 can also have a fastener, such as Velcro 42, to hold plugs 36 within precut holes 38. Plugs 36 can have a slot 44 within the body of plugs 36 to allow for the angler to easy remove plugs 36 from holes 38 when the angler would like to use floor 22. It is fully contemplated other methods of removal for plugs 36 besides a slot 44 could be used without departing from the spirit of the invention, such as a string attached to a hole in plug 36. Covering floor 22 can be a non-slip material 46 to prevent an angler from slipping should water get on floor 22. Most any non-slip surface, such as a water resistant carpet, could be used without departing from the spirit of the invention.

In use, the angler could set floor 22 on the ice. After removing plugs 36, the angler could drill a hole though the ice through precut holes 38 with an auger. The ice removed by the auger could then be pushed off of floor 22. Precut holes 38 are typically 12″ in diameter, which is plenty of room to allow most augers to drill a hole though the ice. However, it is fully contemplated precut holes 38 could be most any diameter within reason without departing from the spirit of the invention. Icehouse 10 can be raised and the angler is ready to go fishing which still keeping warm with an insulated floor beneath him and feel safe from slipping with non-slip flooring 46.

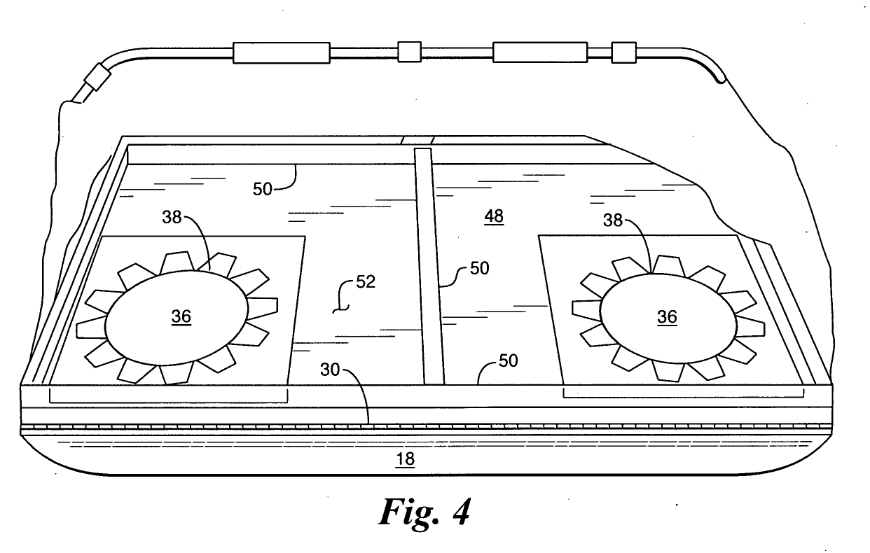

With reference to FIG. 4, a portable ice fishing floor in an embodiment of the present invention is shown. Floor 22 has been folded in half and placed within tub 18 for easy transport. Floor 22 fits nicely within tub 18. Floor 22 can be manufactured to fit with most any portable icehouse manufactures transportation device, such as tub 18. With bottom side 48 exposed frame 50 is shown having a platform 52 on top of frame 50. Frame 50 could be made from most any material, such as wood or metal; however, the inventors have found plastic to make floor 22 lighter and thus easier to transport. Platform 52 could also be made of most any material, such as wood or metal, but the inventor's have found plastic assists in making floor 22 lighter. An insulated plastic could be used to assist in keeping the cold of the ice away from the angler and yet also protecting the ice from melting should the angler have a heater in icehouse 10. It is also contemplated an additional layer of insulation could be attached to bottom side 48 should frame 50 and platform 52 be made of other non-insulated materials.

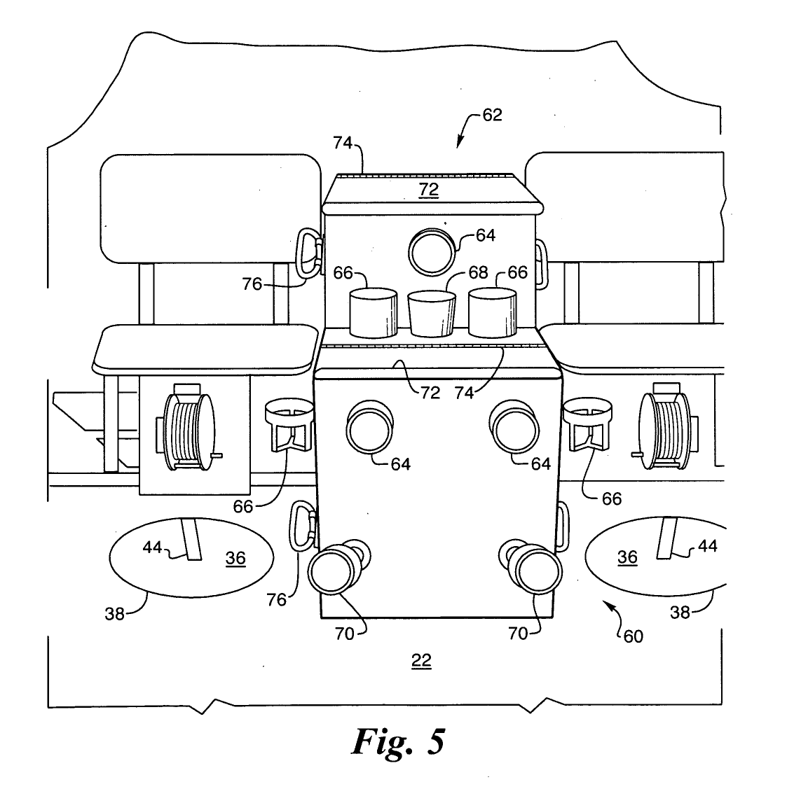

With reference to FIG. 5, an upper front profile view of containers in an embodiment of the present invention is shown. Lower container 60 and upper container 62 can be coupled to floor 22 or used separately. Lower container 60 can be coupled to floor 22 by most any means such as Velcro, a peg and slot fitting or even fastened with a bolt. Most any type of attachment is fully contemplated without departing from the spirit of the invention. Both containers 60 and 62 can have adjustable pivoting lights 64 which can be powered by a battery within container 60 or 62. Typically, lights 64 could be focused upon most any ice fishing hole to provide a better visual fishing experience for the angler, especially if the angler is fishing at night. Containers 60 and 62 can also have other amenities such as cup holders 66, an ashtray 68 or even fishing pole holders 70. Each container has a door 72 which pivots upon an axis 74. Each container 60 and 62 has handles 76 which allow the angler to easily carry both container 60 and 62 to and from the fishing events.

Container 60 is approximately 13″ inches across and lengthwise. Container 62 is approximately 13″ inches across and 16″ lengthwise.

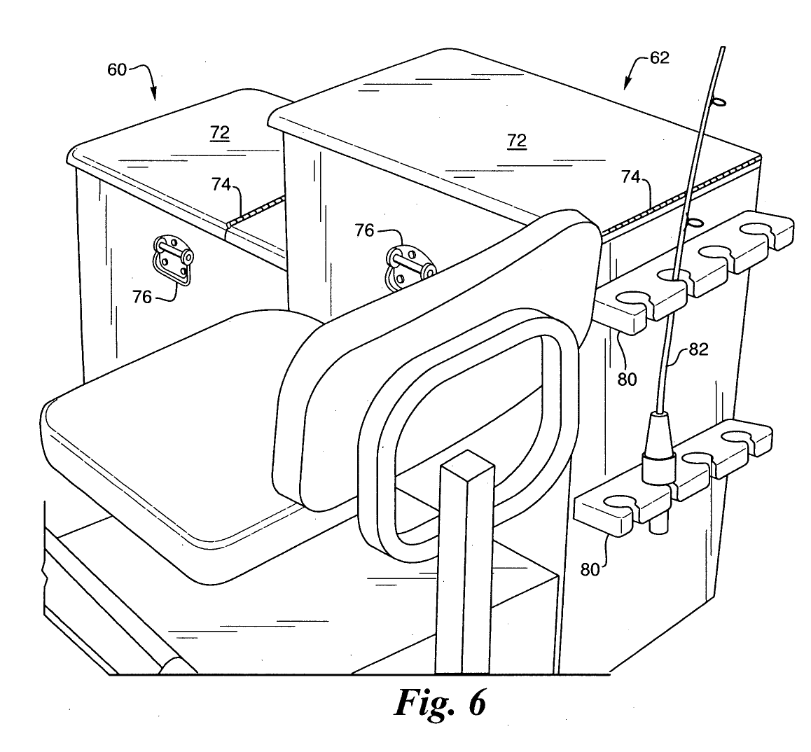

With reference to FIG. 6, a rearview profile view of containers in an embodiment of the present invention is shown. Coupled to the rear of container 62 can be a rod holder 80 for holding fishing rods 82.

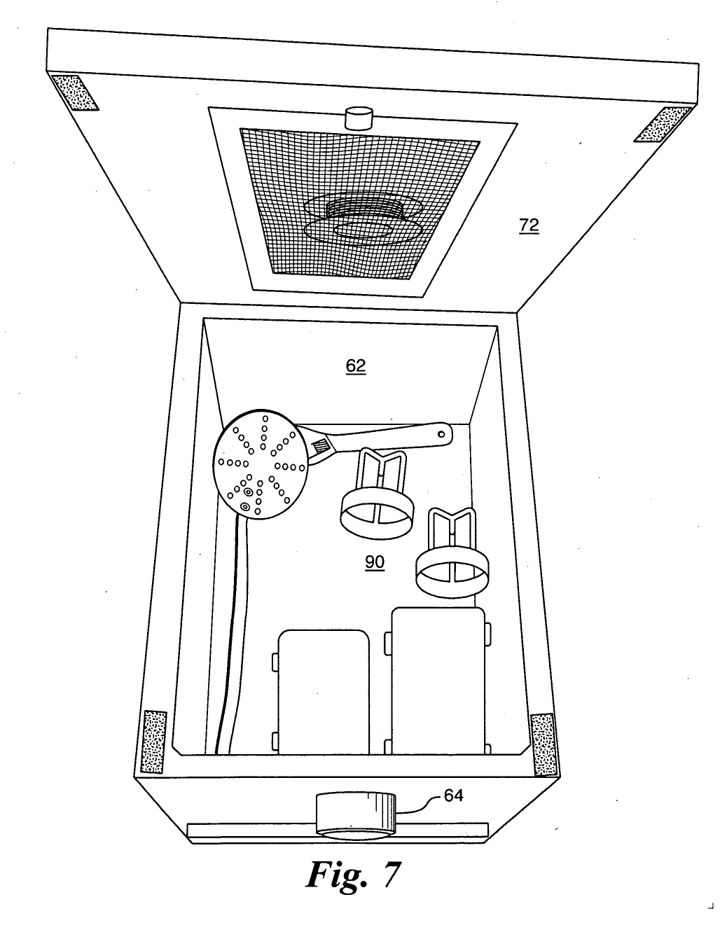

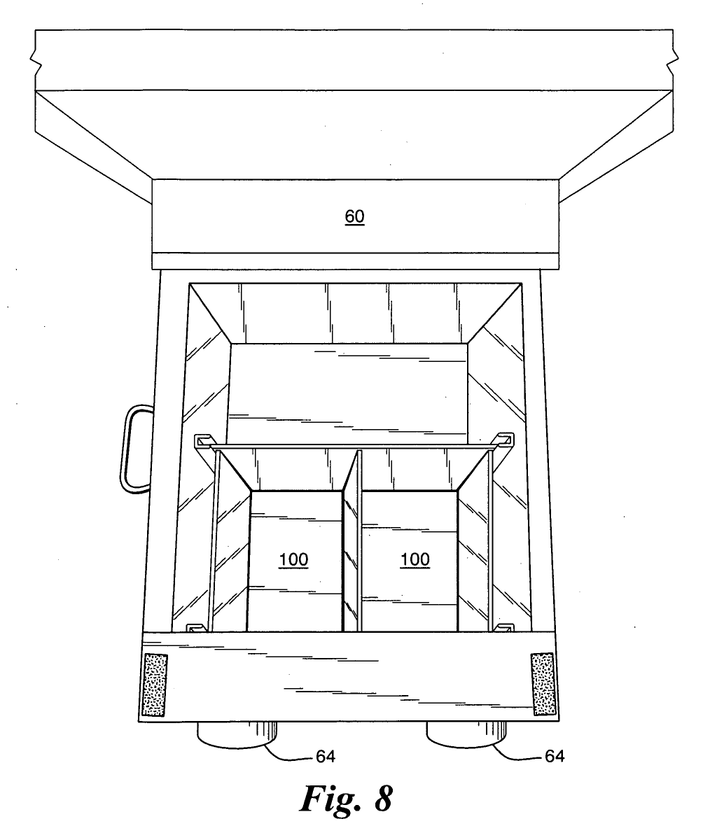

With reference to FIGS. 7 and 8, a top profile view of a container in an embodiment of the present invention is shown. Container 62 has a false bottom 90 which can be pulled from container 62. Underneath of false bottom 90 is a storage space for a battery (not shown) which can power lights 64. Other items can be stored below false bottom 90 as well. In FIG. 8, a bait holder 100 is shown. Bait holder 100 can hold most any type of bait for extended periods of time.

Thus, embodiments of the ICE FISHING UTILITIES are disclosed. One skilled in the art will appreciate the present teachings can be practiced with embodiments other than those disclosed. The disclosed embodiments are presented for functions of illustration and not limitation, and the present teachings are limited only by the claims follow.

What is claimed is:

1. A portable floor, comprising:
a pre-cut hole for an ice fishing auger; and
at least one handle attached to the top surface.

2. The floor of claim 1, wherein the floor may be reduced in size by folding the floor together along an axis.

3. The floor of claim 1, further comprising a plug to fit into and cover the pre-cut hole.

4. The floor of claim 3, wherein the pre-cut hole has an indented, pre-cut ridge around the interior periphery of the hole to support the plug.

5. The floor of claim 3, further comprising a slot in a portion of the plug.

6. The floor of claim 1, wherein the floor may be adjusted in size to fit into a temporary fishing house tub.

7. The floor of claim 1, wherein the floor is made from a non-slip material.

8. A portable floor, comprising:
a frame having a top surface and a bottom surface;
a pre-cut hole in the floor adapted to allow a ice-fishing auger;
a plug to cover the at least one hole; and
a container which is attachable to the floor, the container having a hinged top lid providing access to the interior of the container and a fishing rod holder.

9. The portable floor of claim 8, further comprising an insulated material located adjacent to the frame.

10. The portable floor of claim 8, further comprising a non-slip material coupled to the top surface.

11. The portable floor of claim 8, wherein the floor may be reduced in size by folding along an axis.

12. The portable floor of claim 8, further comprising a means for coupling the container to the floor.

13. The portable floor of claim 8, wherein the container further comprises an additional sealable compartment disposed in the interior of the container for accommodating live fishing bait.

14. The portable floor of claim 8, wherein the surface of the floor is made from a material selected from the group consisting of plastic, insulated plastic, wood and metal.

15. A container, comprising:
a door providing access to the interior of the container,
a handle,
a fishing rod holder; and
a battery-powered light protruding from an exterior of the container.

16. The container of claim 15, wherein the container is for use with a trap-style ice fishing house which may be coupled to a floor of a temporary ice fishing house.

17. The container of claim 15, further comprising a removable false bottom.

18. The container of claim 15, further comprising an additional sealable compartment disposed in the interior of the container for accommodating live fishing bait.

19. The container of claim 15, further comprising at least one cup holder attached to the exterior of the container.

20. The container of claim 15, further comprising a locking mechanism on the hinged top lid for securing the container lid.
